(19) United States
(12) Patent Application Publication
(10) Pub. No.: US 2011/0030221 A1
(43) Pub. Date: Feb. 10, 2011

(54) Multi-Purpose Utensil

(76) Inventor: Matthew Frank, Seattle, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/905,598

(22) Filed: Oct. 15, 2010

Related U.S. Application Data
(63) Continuation-in-part of application No. 12/032,323, filed on Feb. 15, 2008.

(51) Int. Cl. A47J 25/00; B25F 1/00; A47J 17/02

(52) U.S. Cl. 30/113.3; 7/152; 30/279.6

(57) ABSTRACT

The purpose of the Multi-Purpose Utensil is to provide one tool that has a plurality of functions such as a peeler, julienne, sharpener, pitter, among others and, does not occupy any more space than a conventional peeler. A further object of the Multi-Purpose Utensil is to provide an ergonomic handle that can comfortably be used by the left- or right-handed user.

### CROSS-REFERENCES TO RELATED APPLICATIONS

This application is a continuation-in part of application Ser. No. 12/032,323, file on Feb. 15, 2008, now pending and hereby incorporates that application in its entirety by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

### Brief Summary of the Invention

Modern kitchens, whether commercial or residential, are cluttered with multiple hand-held utensils for peeling fruits and vegetables, making juliennes of various sizes, a knife or blade sharpener, among others. Kitchens are further cluttered by utensils that can be used only by the right-handed user.

Information relevant to attempts to address these problems can be found in: U.S. Chapman, Pub. No. 2007/0186423 (Pub. Date August 2007); Di Bitonto, U.S. Pat. No. 7,140,111 (Patent Date November 2006); Ruiz, U.S. Pat. No. 6,671,964 (Pat. Date January 2004). However, each of these references suffers from one or more of the following disadvantages:
(1) does not provide a single utensils that can peel thick and thin skinned fruits and vegetables;
(2) does not provide multiple tools in one utensil;
(3) does not provide a utensil that can be comfortably used by both left- and right-handed users.

The object of the Multi-Purpose Utensil is to provide a tool that can peel both thick and thin skinned vegetables and fruits. Another object of the Multi-Purpose Utensil is to provide one tool that has a plurality of functions such as a peeler, julienne, sharpener, pitter, among others and, does not occupy any more space than a conventional peeler. A further object of the Multi-Purpose Utensil is to provide an ergonomic handle that can comfortably be used by the left- or right-handed user.

### BRIEF SUMMARY OF THE INVENTION

The purpose of the Multi-Purpose Utensil is to provide one tool that has a plurality of functions such as a peeler, julienne, sharpener, pitter, among others and, does not occupy any more space than a conventional peeler. A further object of the Multi-Purpose Utensil is to provide an ergonomic handle that can comfortably be used by the left- or right-handed user.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an elevation view of the multi-purpose utensil;

FIG. 2 is an expanded view of the multi-purpose utensil;

FIG. 3 is a cross section of FIG. 2 at II-II;

FIG. 4 is a cross section of FIG. 3 at I-I;

FIG. 5 is a cross section of FIG. 3 at III-III.

### DETAILED DESCRIPTION OF THE INVENTION

While preferred embodiments of the invention will be shown and described, it will be obvious to those skilled in the art that changes and modification may be made therein without departing from the invention in its broader aspects.

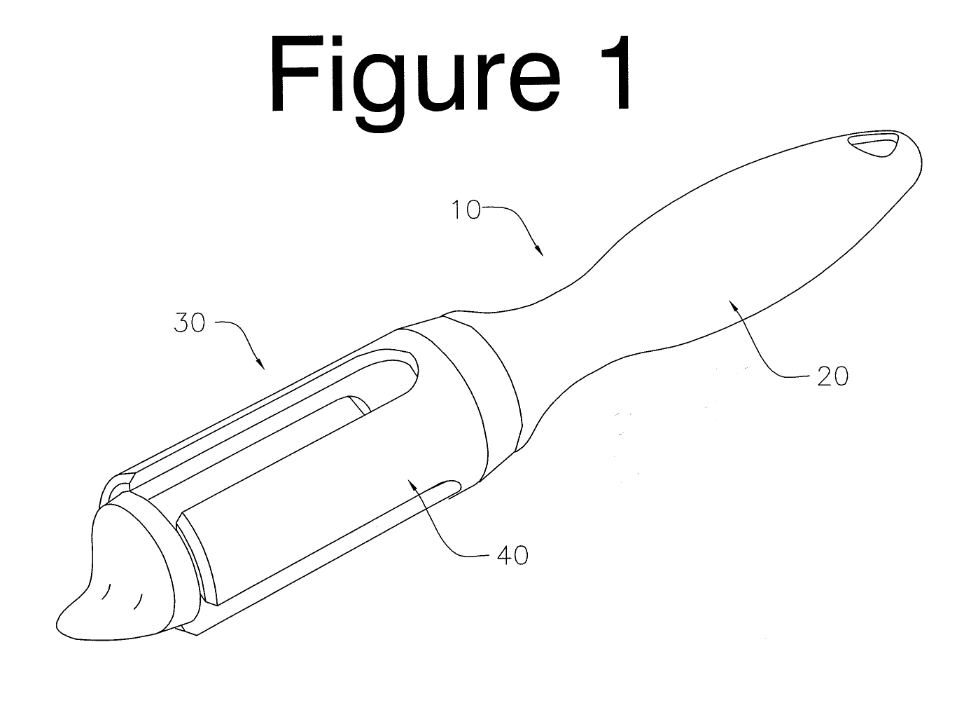

The Multi-Purpose Utensil is a kitchen tool with a plurality of uses. Referring to FIG. 1, the multi-purpose utensil 10 comprises in combination a handle 20, a blade end 30, and a blade guard 40.

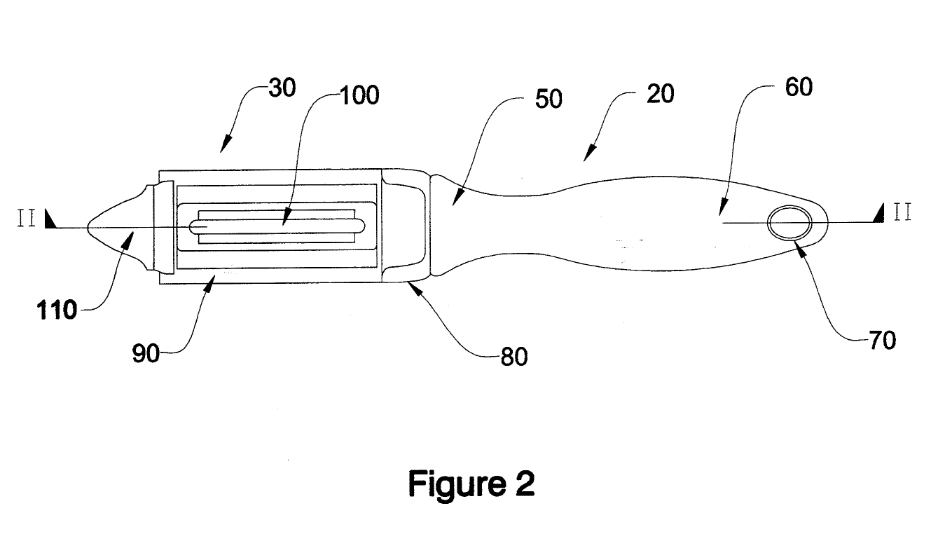

Referring to FIG. 2, the handle 20 consists a mounting end 50 and a gripping end 60. The shape of the handle 20 is ergonomic allowing either a left- or right-hand user to comfortably use the multi-purpose utensil.

In the preferred embodiment, the gripping end 60 of the handle 20 defines a mounting hole or hanger eye 70. The gripping end can also comprise a can opener or a pitter.

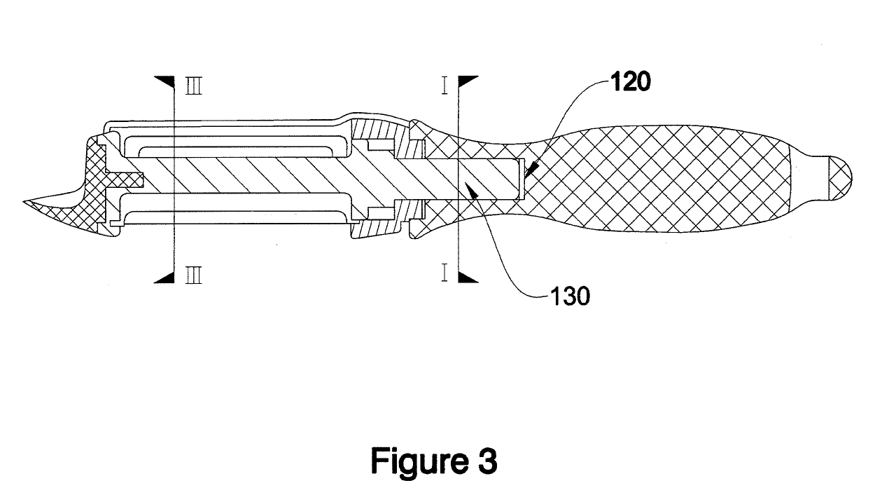

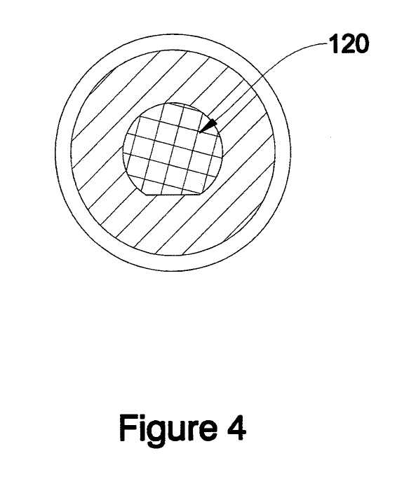

The blade end 30 comprises a proximal end 80 and a distal end 90. Referring to FIGS. 3 through 5, the proximal end 80 of the blade is permanently attached to the mounting end 50 of the handle 20. In the preferred embodiment the mounting end 50 has defines a bore (120) and the proximal end (80) comprises an arm (130). The arm (130) sits in the bore (120) and is attached permanently thereto. In the preferred embodiment, the distal end 90 further comprises a pitter 110.

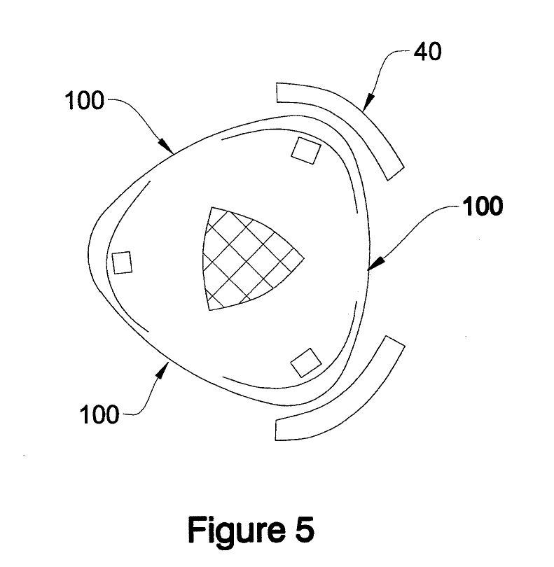

The blade end 30 comprises a plurality of blades 100. Referring to FIG. 5, in the preferred embodiment, there are three blades 100 which are placed symmetrically, 120 degrees from each other; each blade has a different function. The blades can peel, julienne, or sharpen, among other functions.

Referring to FIG. 5, in the preferred embodiment, the blade guard 40 is attached to the proximal end 80. The blade guard 40 will rotate to cover the blades 100 not in use, allowing the multi-purpose utensil to function as a single utensil. In the preferred embodiment, the blade guard 40 is removable so that it can be washed separately from the handle and blade end.

What is claimed is:

1. A Multi-Purpose Utensil (“Utensil”) comprising in combination:
a handle;
a blade end, said blade end comprises a plurality of blades
a removably attached blade guard.

2. The Utensil of claim 1, such that blade end comprises a proximal end and a distal end; said proximal end comprises an arm.

3. The Utensil of claim 1 such that the handle consists of a mounting end and a gripping end; said mounting end defines a bore.

4. The Utensil of claim 2 such that the arm sits in the bore of claim 3 and is permanently attached thereto.

5. The Utensil of claim 3 such that the gripping end is ergonomic so that either a left or right handed person can use the Utensil.

6. The Utensil of claim 3 such that the gripping end comprises a can opener or a pitter.

7. The Utensil of claim 1 such that the blade guards rotates around the plurality of blades concealing blades not in use.

8. The Utensil of claim 1 such that blade guard is separable from the handle and the blade end.
